(19) United States
(12) Patent Application Publication
(10) Pub. No.: US 2002/0161640 A1
(43) Pub. Date: Oct. 31, 2002

(54) Method for the wireless delivery and redemption of merchant discount offers

(76) Inventor: Jason Wolfe, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/096,555

(22) Filed: Mar. 13, 2002

Related U.S. Application Data
(60) Provisional application No. 60/275,039, filed on Mar. 13, 2001.
(60) Provisional application No. 60/307,138, filed on Jul. 24, 2001.

(51) Int. Cl. G06F 17/60

(52) U.S. Cl. 705/14

(57) ABSTRACT

Disclosed is a process by which merchants are able to provide discount offers, such as coupons, incentives, or tokens to consumers. Discount offers are arranged on a web site (or delivered other wise by RF) by category and users are able to pick and choose the offers in which in which they are interested for storage in a personal coupon folder. Merchants are able to bid for placement within each category and are also able to slot their offers in specific users' personal folders. Discount offers are wirelessly delivered from the users' personal folders to a wireless receiving device, where they can be transferred to a display device for direct scanning at the point-of-sale. The display device according to this invention has the capability to communicate directly with the receiving device and to display the coupon UPCs via a scannable media.

### RELATED APPLICATIONS

This application claims the benefit of pending U.S. provisional applications Serial Nos. 60/275,039, filed Mar. 13, 2001 and 60/307,138, filed Jul. 24, 2001.

### FIELD OF THE INVENTION

This invention relates to the field of merchant discount offers, most commonly in the form of coupons, incentives, or tokens, which can be redeemed for a retail discount on various consumer products and services, and, in particular, relates to the paperless delivery and redemption of such offers.

### BACKGROUND OF THE INVENTION

The use of discount merchant discount offers for products and services is well known in the art and have been in use for decades. Typically, such discounts are issued by manufacturers for a product or product family, to promote sales and brand loyalty. Additionally, discount offers may be issued by specific retailers to induce consumers to visit that particular retailer in favor of others selling similar products or offering similar services. As such, the term “discount offer” as used herein, shall mean any such offer, whether offered by a manufacturer, retailer or any third party, and regardless of the form such an offer takes.

Traditional discount offers are printed in paper form and are distributed via a variety of methods, such as publication in a newspaper or magazine, direct mailings to targeted consumers, or directly at the point of sale. Typically, discount offers have information thereon indicating the discounted products or services, the party responsible offering the discount, an expiration date, and, in most cases, a Universal Product Code (UPC) which can be scanned by a checkout clerk at a register for purposes of verifying the purchase of the qualifying products and the validity of the coupon.

Many problems exist for all parties involved in the process of distribution and redemption of discount offers. First, discount offers in the form of paper coupons are expensive to print and distribute. Only a small percentage of paper coupons distributed, typically less than 3%, are ever redeemed by a consumer. Further, distribution methods used with paper coupons are not generally not adapted to optimizing the distribution to those most likely to be interested in a particular product, and the methods of distribution do not promote impulse-based sales.

For the retailer, coupons collected from consumers must be sorted and forwarded to manufacturers or clearinghouses for reimbursement. The physical handling of the coupons is expensive, error-prone and subject to fraud.

For consumers, the use of paper coupons is cumbersome and inconvenient. Coupons must often be clipped from publications and the consumer must physically have the coupons on his person when shopping. Sorting though a stack of coupons to assist in the selection of a particular product while at the retailers establishment is time-consuming. Further, the checkout process is slowed for the consumer and other consumers waiting in line for verification of product purchases and the proper crediting of the consumer's bill to account for the discounts

Lastly, a major drawback of paper coupons lies in the anonymous nature of their redemption. Valuable marketing information can be realized by analyzing the purchasing habits of consumers and correlating this information with the consumers' demographic profile. Coupon issuers will, in most scenarios utilizing paper coupons, lose the information regarding what “types” of consumers are purchasing their products. Such information can be used for targeted advertising via a variety of methods to increase brand loyalty and promote further sales of specific products to specific consumers.

Therefore, it would be advantageous to provide a method by which the negative aspects of paper-based couponing are alleviated or eliminated, and which allows the collection of valuable purchasing information.

### SUMMARY OF THE INVENTION

The present invention provides an apparatus and method for the paperless delivery and redemption of discount offers. There are several aspects to this invention. In the first aspect, a process is disclosed whereby advertisers are able to place discount offers on an Internet site where the offers are sorted by category. Merchants bid for placement of their offers within each category, with the top bidder getting the first or prime placement, in the hopes of generating more responses than other offers listed in the same category. Users of the Internet site are then able to transfer the offers to personal folders on the site.

In a second aspect of the invention, merchants can also “slot” their offers against another company's offers. The slotting feature provides the means whereby a merchant can chose to have their coupon slotted into the folder of the user for products that fall in line with their product line, based on past and future events. For example, if a user buys a 2 liter bottle of coke with a $0.50 discount offer from Coca-Cola, we can allow Pepsi to immediately put a Pepsi coupon into their folder. Additionally, because it is known that the user has redeemed or is about to redeem the Coke offer, we can allow Pepsi to slot an offer for $0.55 to beat the value of the Coke offer.

In another aspect of the invention, electronic discount offers can be wirelessly delivered from the user's online folder into a mirror of the user's folder on a mobile smart device via an RF-enabled intermediary device.The intermediary device can be any one of a number of well known technologies, such as a cellular telephone, a personal data assistant (PDA), a hand held computer, a cash register at a merchant location, a stand-alone kiosk, or any other device capable of receiving content and then relaying it on to the smart device. The only requirements for the intermediary device are that it be able to communicate in some manner with an infrastructure through which the discount offers are delivered, and be able to transmit those offers via a wireless means, such as via RF, to the user's personal folder in the smart device. Information regarding the specifics of the advertiser's offer can be displayed on the display of the intermediary device, or the user's smart device.

Lastly, electronic discount offers are preferably redeemed by the consumer via a direct scanning of a bar code. Because a bar code cannot be scanned directly with conventional scanners from an LCD display, such as is typically found on a cellular telephone or PDA, the user's smart device is preferably equipped with a special display which can display the bar code in a manner that allows it to be scanned by conventional checkout scanning means.

### DESCRIPTION OF THE DRAWINGS

FIG. 1 is an example of a page on the Internet site of the present invention which would be used by a merchant to enter a discount offer.

FIG. 2 shows a continuation of the page shown in FIG. 1.

FIG. 3 shows a page on the Internet site of the present invention used by a merchant to bid for placement of its discount offer in one or more categories of offers.

FIG. 4 shows a page on the Internet site of the present invention which would be used by a consumer to login and search for discount offers.

FIG. 5 shows the results of a consumer search for discount offers using a ZIP code.

FIG. 6 shows a page used by a consumer to enter search criteria, namely ZIP code or keyword.

FIG. 7 shows the results of a search for discount offers based on the current location of the consumer.

FIG. 8 shows the details of one of the discount offers shown in FIG. 7.

FIG. 9 shows the details of a discount offer displayed on the LCD screen of a receiving device after being wirelessly delivered thereto.

FIG. 10 shows the details of a second offer displayed on the LCD screen of a receiving device after being wirelessly delivered thereto.

FIG. 11 is a schematic drawing of the process of wireless delivery of the discount offer to a receiving device, in this case a cellular telephone.

FIG. 12 shows the redemption of a wirelessly delivered discount offer by scanning via a conventional checkout bar code scanner.

FIG. 13 shows the redemption of a wirelessly delivered discount offer by providing the discount offer code, which can be read by the consumer from the display of the receiving device and manually entered by the checkout clerk.

FIG. 14 shows the RF-enabled special display device according to the present invention which provides the capability for scanning the bar code directly therefrom.

FIG. 15 shows various types a PDAs and a cellular phones equipped with the display device shown in FIG. 14.

### DETAILED DESCRIPTION OF THE INVENTION

The invention is centered around an Internet web site that allows users to log on and browse a selection of discount offers. Discount offers are arranged by product or service categories, such as “grocery,” “home” and “computers & electronics.” Merchants can place discount offers online into one or more categories. A merchant, for purposes of this application, is typically a manufacturer of a product or a retailer providing products or services. A discount offer is a typically a discount off of retail price for a product or service offered by the merchant. The discount offers typically take the form of a) a percentage discount off of retail price, b) a buy one get one free discount, or c) a face value real dollar discount off of the retail price.

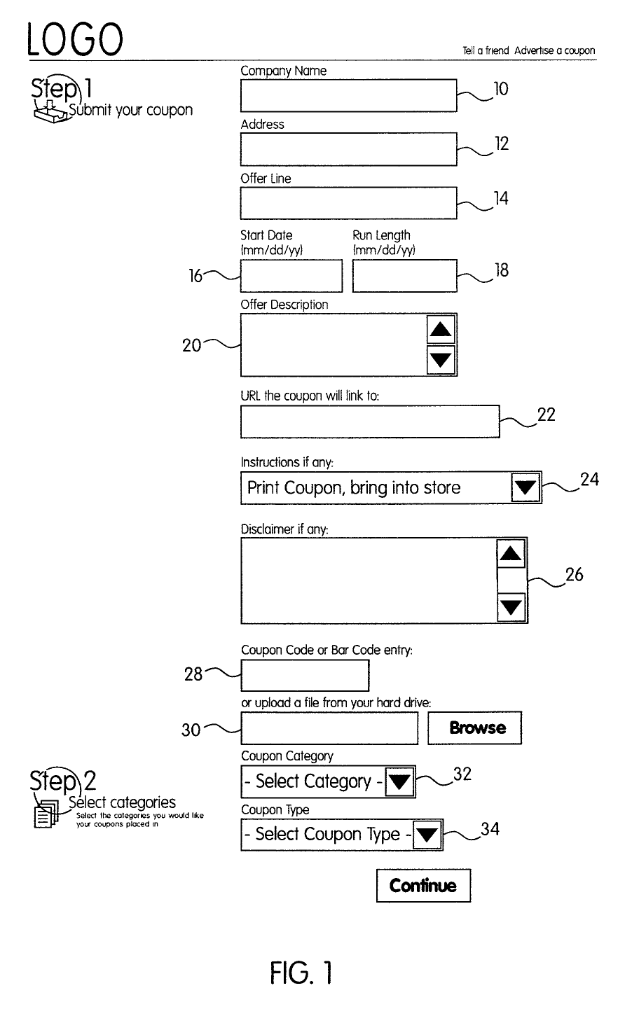

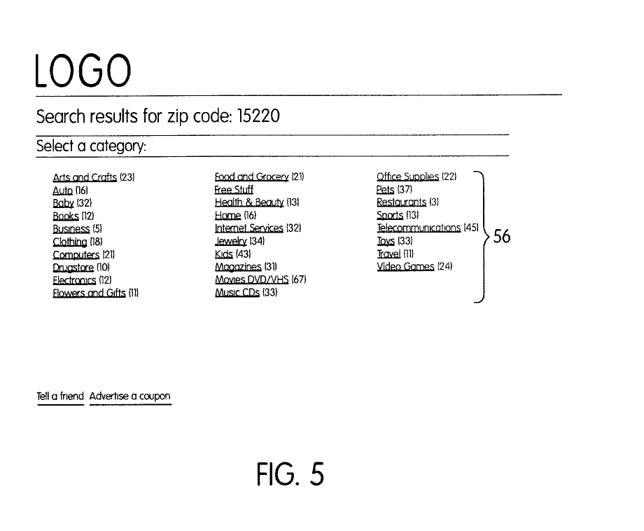

FIG. 1 shows an exemplary page on an Internet website which allows a merchant to enter a discount offer. The merchant is able to enter his company name and address in spaces 10 and 12 respectively. Space 14 provides a spot for the merchant to place a one line advertisement for the offer. The period during which the discount offer is valid is entered as a starting date and an ending date in spaces 16 and 18 respectively. Space 20 provides a spot for the merchant to place a detailed description of the discount offer. In space 22, the merchant can provide a URL where the user may click to redeem the coupon, if the coupon is of the type that can be redeemed on-line. Space 24 allows the merchant to enter any specific instructions for redemption of the coupon. Space 26 provides a spot for the merchant to provide any kind of legal disclaimers associated with the discount offer. Spaces 28 and 30 provide a space for the merchant to specify a numerical code for the discount offer either in the form of a code which is entered using the keyboard in space 28, or a file which can be uploaded from the merchant's computer, which contains an image of a bar code in space 30. Space 32 provides a place for the user to select which category the coupon primarily pertains to. Examples of coupon categories include, but are not limited to, those shown in FIG. 5.

In space 34 the merchant is able to select the type of offer. The type of offer effects how the offer is delivered to the user and how the user redeems the offer. The offer can be one of four pre-defined types. The types of offers is summarized below:

Online Code: the user clicks on the offer and receives a special code. The user then goes to the web site of the merchant making the offer and enters the code at some point during the purchase process, usually at checkout, and the discount is then applied. A hyperlink to the merchant's web site may be provided.

Online Link: The user clicks on a hyperlink to the merchant's web site which goes to a special page where the discount offer can be redeemed. Typically, such a page may not be accessible to the general public, but only accessible through the special hyperlink provided on the web site associated with the present invention.

Wireless Delivery: the coupon is wirelessly delivered to the user's smart device where it can be displayed on the screen of the smart device such that the user can provide the discount offer code to the checkout motion for manual entry into the checkout register, or wherein the bar code can be displayed on the special display device of the present invention for scanning with the conventional checkout scanner at the point of sale.

As part of the process by which discount offers are placed on the Internet web site, the merchant is permitted to bid on a per category basis for placement for the coupon within the category. Merchants can also bid on placement broken down by the ZIP codes of the users. The high bidder receives the best placement of their discount offer, or a placement of their offer that is likely to generate the most interest by the users. Such offers are placed in a featured area or a prime location, such as at the head of a particular category or at the head of a list containing offers for a particular ZIP code. Lower bidders receive less desirable placements of their advertisements. Merchants not wishing to bid have their advertisements placed into a generalized list for the particular category or zip code.

Merchants bidding for placement of their discount offers can see in real time what their competitors are bidding for best placement and can out-bid their competitors. Merchants are also able to see in real time the number of people that have elected to redeem specific offers. As a result, the merchants can make a decision to outbid their competitor for the top spot in the specified category, based on price and the number of people electing to redeem a specific coupon in that category.

The bidding for the top spot can take several forms. In the preferred embodiment, merchants place a bid for the top spot based on an amount to be paid per coupon redemption. For example, if a merchant bids 25¢ for the top spot, 25¢ is paid each time a user redeems the coupon in the top spot. In other embodiments, different methods of bidding are possible. Other examples include bidding an amount to be paid each time a user views a coupon, or bidding a flat amount for the top spot, not based on coupon viewings or redemptions.

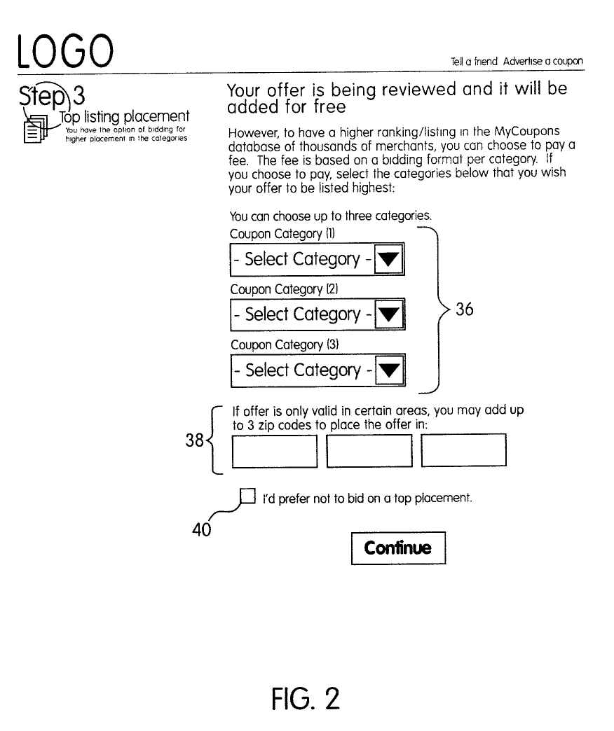

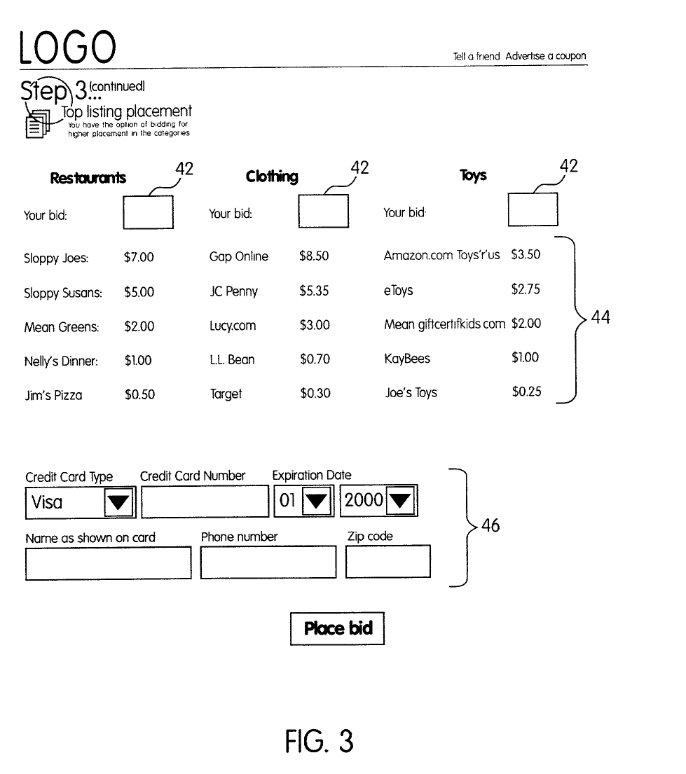

FIG. 2 shows an exemplary page on-line where the merchant can submit bids for top placement of his discount offer according either to a number of categories or a number of ZIP codes. In spaces 36, the merchant can select up to three categories in which he wishes to bid for top placement. Alternatively, or in addition to that, the merchant can specify a plurality of ZIP codes where he wishes to bid for top placement of the discount offer. Should the merchant not wish to make a bid for top placement, box 40 can be checked. FIG. 3 shows the page where the user can enter bids for top placement for specific categories. In this case, as shown in FIG. 3, the merchant has chosen to place his discount offer in the restaurant, clothing and toys categories. The merchant is also shown, in area 44, the current bids for top placement in the various categories. If the merchant outbids the top bidder, the merchant's offer receives top placement in that category, that is, the offer is placed in the most advantageous spot within that category. Merchants bidding lesser amounts are placed in less advantageous spots but will still be placed in a more advantageous spot then a merchant choosing not to bid for top placement.

Shown here is a method wherein the merchants bid a flat dollar amount for top placement. Alternatively, as stated previously, merchants can also bid on a per redemption amount. Provided in space 46 is a method whereby the merchants bids are paid.

An additional feature of the invention is the ability for merchants to have their discount offers “slotted.” Slotting is the ability for a merchant to have his offer placed into a user's personal folder when the user places a competitor's offer into his personal folder or when the user redeems a specific coupon of a competitor of the merchant. The placement of a merchant's coupon into the user's personal folder when a competitor's coupon is placed there by the user allows the merchant the ability to place a more desirable (i.e., a larger discount) offer in to the user's folder, in the hope that the user will redeem the merchant's offer instead of the competitor's offer. Offers can also be slotted based on past redemptions of offers, by either the same or a competing merchant for similar or complementary products. For example, if a user redeems a coupon for a mop, an advertiser may have a coupon for a floor cleaner slotted into the user's personal folder. Likewise, if a user has in the past redeemed an offer for a competitor's product, the merchant may slot an offer for its competing product.

Users (consumers) can log into the web site and browse the discount offers by category to decide if they are interested in the particular offers being advertised. Users can look at offers and save offers of interest in a personal folder for later redemption. In an additional embodiment of the invention, coupons can be placed into a user's folder automatically based on past and predicted buying patterns.

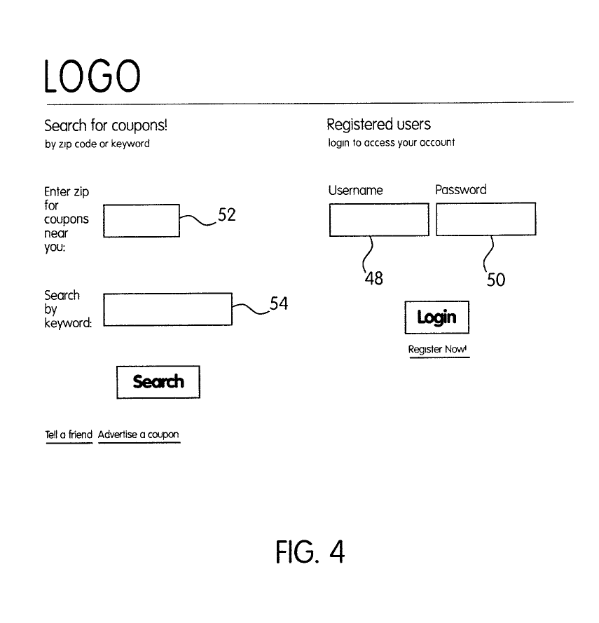

FIG. 4 shows an exemplary page on the website of the present invention which is used by users. The user logs on as a user by entering a user name and password in spaces 48 and 50 respectively. The user is then able to enter a zip code in space 52 or a keyword in space 54 by which to search coupons. FIG. 5 shows the results of a search based on the use of a ZIP code as a search criteria. In area 56 of the results, the available discount offers in that particular ZIP code are broken down by category with the number of offers being shown for each category.

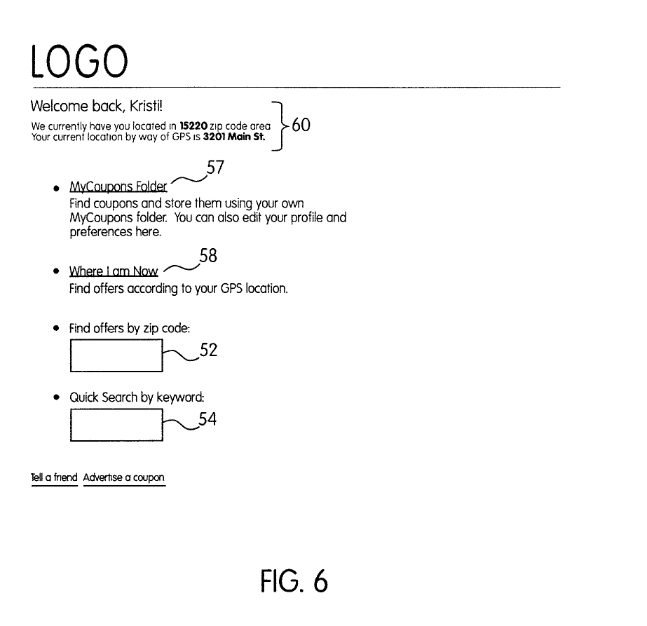

FIG. 6 shows the main page seen by the user after logging in. As can be seen in area 60 of this page, it is possible for the system to detect the current location of the user if the user's intermediary device or smart device is equipped with a GPS receiver. The knowledge of the user's location can also be used as a search criteria for coupons. Hyperlink 57 will take the user to the user's personal folder where any coupon found on the website can be stored for later redemption. Hyperlink 58 provides the user with the opportunity to search for coupons based on the GPS-supplied current location of the user and, as shown on the previous Figure, users can also search for coupons by ZIP code or keywords in spaces 52 and 54 respectively. It should be noted that, in FIG. 6, the type of search done by the user's current location as provided by GPS is only meaningful when done from a wireless web-enabled appliance such as a PDA or web enabled cellular telephone, which can connect to the website through a mobile Internet connection. Alternatively, the user's mobile smart device may be equipped with a GPS-receiver to provide location awareness.

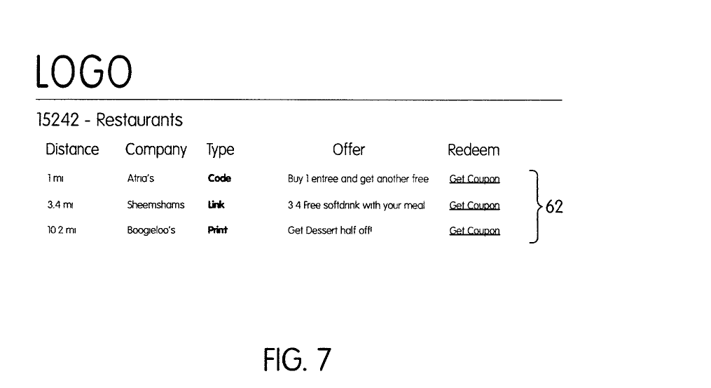

FIG. 7 shows the results of a typical search for a restaurant based on the user's current location as applied by GPS. In area 62 of the figure, three restaurants which are providing discount offers and which are in close proximity to the user are shown. Shown is the name of the restaurant, the distance to the restaurant from the user's current location, the type of discount that is being offered, the specifics of the offer and a hyperlink to click to redeem the offer. In this case the consumer would go to the restaurant providing an offer and click on the hyperlink under the redeem column to redeem the coupon at the appropriate time.

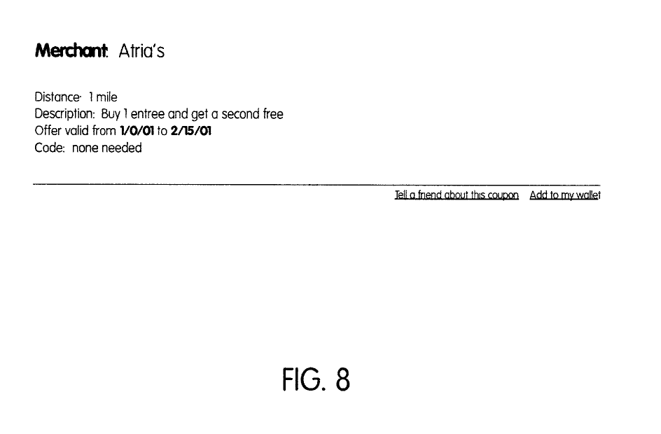

FIG. 8 shows what is displayed on the user's device when the user chooses to redeem the offer. In this case, it specifies that no code is needed to redeem the offer, however, different offers could provide a requirement that a code be provided to the merchant for manual entry into the checkout register or could provide a bar code which should be displayed on the special display device described later according to this invention.

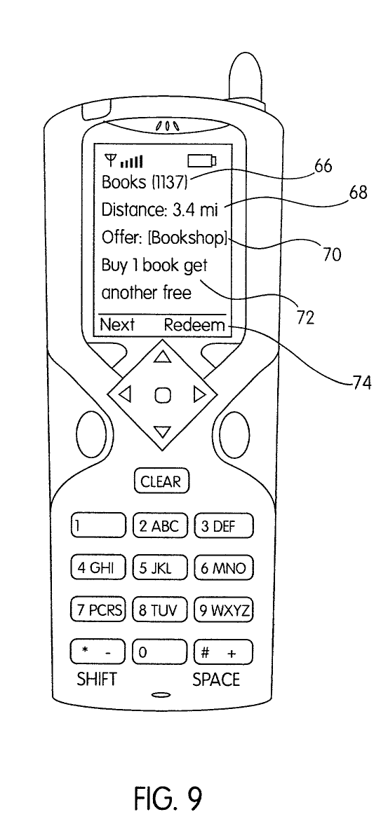

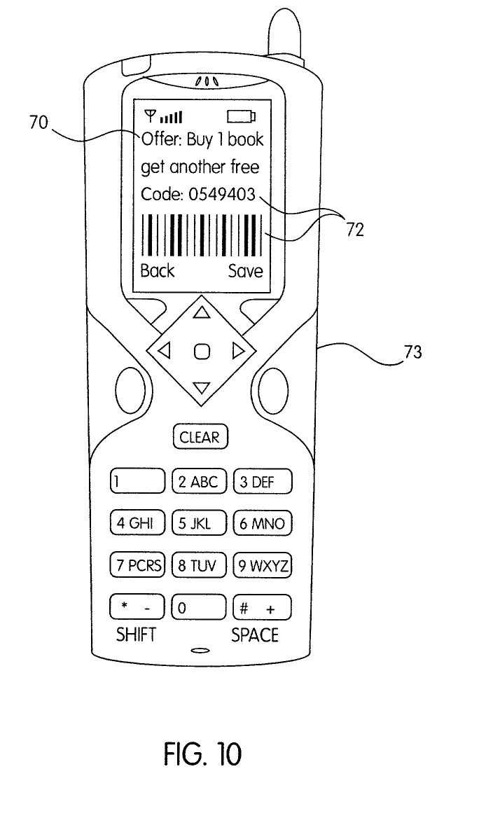

FIGS. 9 and 10 show a cellular phone which is acting as an intermediary device for a wirelessly delivered discount offer. In this case the smart device is not being used and the specifics of the offers are displayed on the display of the intermediary device. The category 66, distance from the user 68 (as calculated using the user's current GPS provided location), the name of the merchant 70 and the specific details of the offer 72. The user is able to redeem the offer by pressing one of the “action” buttons on the cell phone 73. Possible actions are to redeem the coupon immediately or to save the coupon in the user's personal folder on the Internet website and in the user's mobile smart device. To redeem the offer the user could read the code from the display and the checkout clerk could enter the code into the merchant's checkout register.

Another aspect of the invention involves the process by which wireless discount offers are delivered and redeemed. As stated previously, discount offers can be delivered via a variety of means, however, the wireless delivery method is the preferred method according to this invention and provides the most flexible and convenient delivery method for both the merchant and the user.

To delivery wireless discount offers, it is necessary to have a delivery mechanism as well as a receiving mechanism. The delivery mechanism can be in the form of a centralized computer server or server cluster which contains merchant offers that can be stored and retrieved by users, or a remote computer server in the merchant location that contains a database of offers that the user can access. Additionally, a peer-to-peer system can be provided which provides the ability for a user to transfer offers from their own smart device to the smart device of another user. The computer system delivering the wireless offers to the users may be the same system on which the Internet web site is running, or another system. Alternatively, a merchant can be provided with offers which can be sent to the user's smart device via RF when the user enters the merchant's establishment.

For the users, an intermediary device is necessary to receive the coupon offers. The intermediary devices must be connected to some type of infrastructure capable of transmitting data-based messages, preferably wirelessly. Examples of such devises which are currently available include cellular telephones, wireless personal data assistants (PDAs), handheld computers and beepers. Alternatively, the intermediary device may be stand-alone kiosk, a store isle, a specific product shelf tag, or a register at a merchant's location. The intermediary devices must be capable of receiving the offers in some manner from the computer on which the offers are stored and must also be capable of communicating with the mobile smart devices of the users, preferably via an RF link.

Intermediary devices must be able to communicate with the smart device either via a wireless method or via a wired hot sync. Other methods of communication may also be available, such as the ability to transfer data from device to device via infra-red, such as is currently available on some PDAs, which could provide the previously mentioned peer-to-peer service. Preferably, the intermediary devices will also have the ability to receive and display text and/or images, such that the details of various coupon offers can be displayed to both the user and merchants.

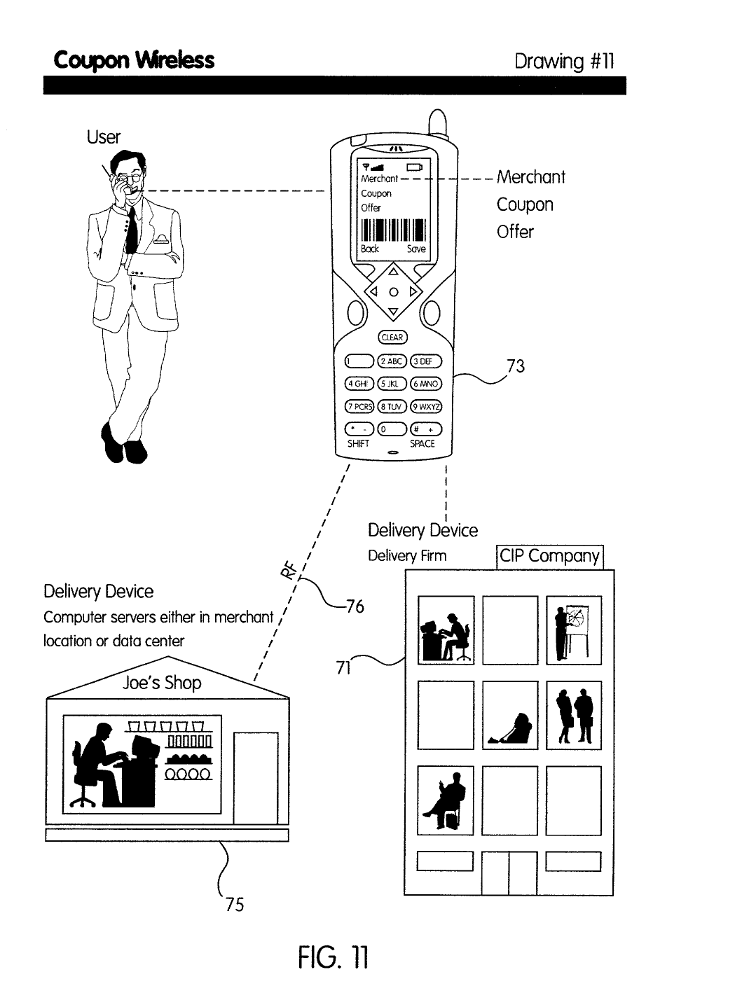

When coupon offers are received by the intermediary device, as the result of the placement of an offer in the user's online personal folder, they may be stored in the memory of the device until they are transmitted via an RF link to the user's smart device or redeemed by the user. Alternatively, users can connect to the delivery device in real time to receive coupon offers, such as is the case when performing a search based on the GPS-provided current location of the user. FIG. 11 shows a schematic of a typical delivery by wireless means of a discount offer to a user's intermediary device. In the first instance, company 71 is able to directly deliver the coupon via a wireless infrastructure to the user's intermediary device, in this case, a cellular telephone 73. In a second embodiment, a merchant's 75 in-store system acts as an intermediary device.

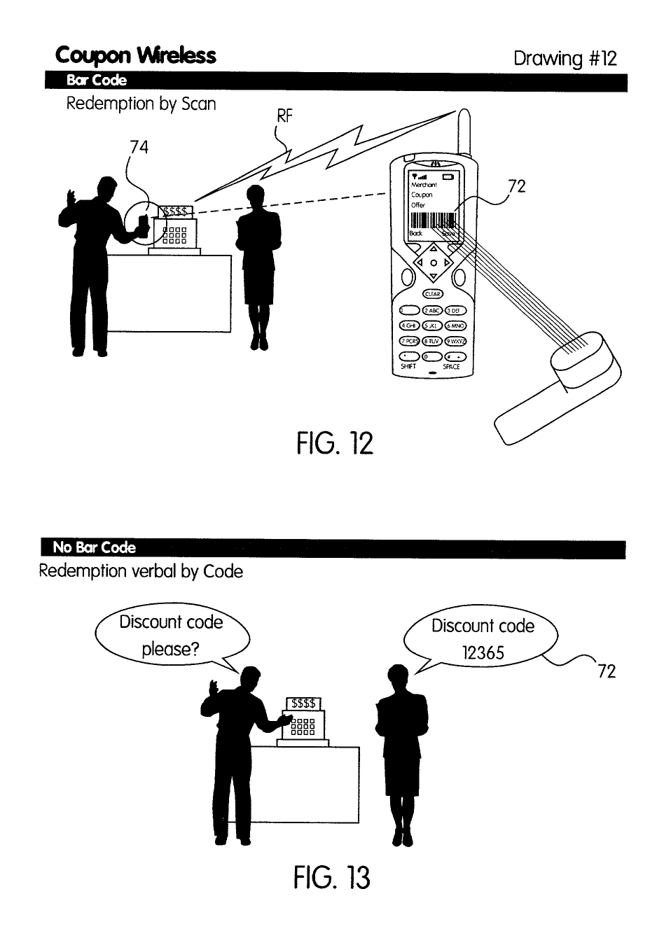

FIGS. 12 and 13 show the various processes by which the electronically delivered coupon can be redeemed in a merchant's store. In FIG. 12 the discount offer is scanned via a barcode directly from the user's smart device. Alternatively, if the merchant's checkout register is RF-enabled, the offers could be uploaded from the user's smart device directly to the register via the RF link. FIG. 13 shows the second method of redeeming coupons at a merchant's site, in this case the discount code is read from the intermediary device and entered manually by the checkout clerk into the merchant's checkout register.

Another aspect of this invention, provides the previously mentioned smart device which can communicate with the intermediary device and which can display a scannable bar code. This is the preferred method of coupon delivery contemplated by this invention. The smart device is preferably a small device which could be carried by the user on a keychain or which could be affixed to the rear of the intermediary device via an adhesive strip, and is discussed in more detail below.

In the preferred embodiment, both the smart device and the intermediary device would be supplied with a communications technology, preferably an RF link, such as Bluetooth™, which would allow a communication therebetween. However, in a less-preferred embodiment, the intermediary device and the smart device could be connected via a cable. To display the UPC code, the smart device is provided with a scannable display media. Several types of scannable media exists, such as e-ink, produced by E-Ink Corporation of Cambridge, Mass.

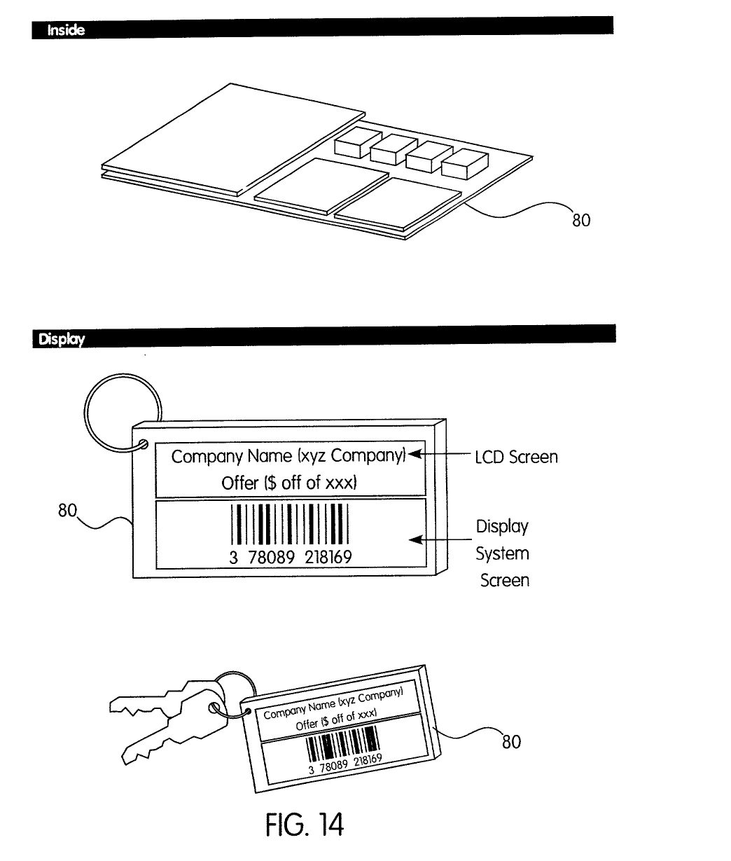

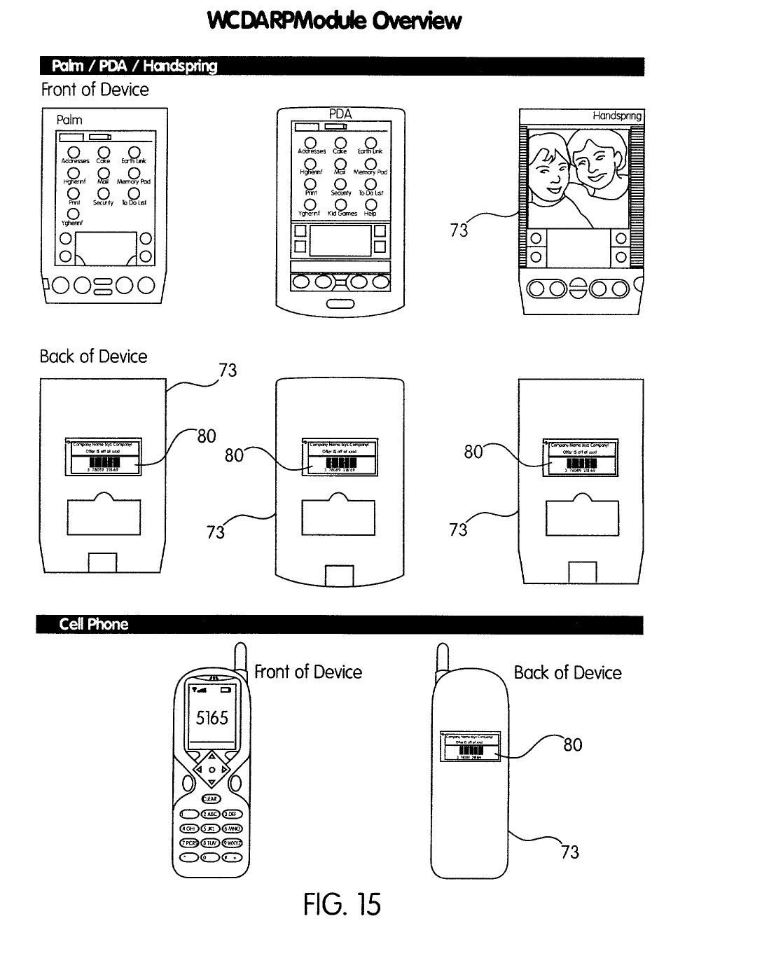

The smart device as contemplated by this invention is shown as reference number 80 in FIG. 14. As can be seen in FIG. 14, the device is preferably small enough to be carried on a user's keychain, in a wallet, or attached to a wireless phone or PDA. The device itself includes a processor, a memory module to store the user's personal folder containing various offers, the scannable display to display the barcode as discussed above and a Bluetooth™ RF module or some other RF module to allow communications with the receiving device. The smart device may also be provided with a GPS receiver to make it location aware. FIG. 15 shows various types of devices that could be used as an intermediary device, such as a PDA or a cellular phone. Shown in particular is display device 80 attached to the rear of the intermediate devices 73 via some sort of conventional adhesive.

The combination of the intermediary device and smart device allows the delivery and use of a highly secure coupon which can not be duplicated.

In operation, the user logs onto the user web site and selects offers of interest, which he then moves to his online personal folder. Offers in the user's personal older are automatically transmitted to an intermediary device, such as a cellular phone or web-enable PDA. When the smart device comes in close proximity to the intermediary device, the offers are sent via the RF link to a mirror personal folder on the user's smart device, where they are stored until redeemed or deleted by the user.

In another embodiment, the intermediary device may be a RF-enabled kiosk or a merchant's RF-enabled checkout register. In this case, offers may be downloaded in to the user's smart device via the RF-link which the user did not explicitly place into his online personal folder. Such offers may be selected for download to the user's smart device based on other criteria, such as, for example, location or merchant.

It is also contemplated by this invention that the smart device could act as an electronic wallet and authorize electronic payments from the electronic wallet via the RF link.

In yet another aspect of the invention, it is possible that the bar code displayed by the user's smart device represents not a single merchant offer, but several merchant offers which the user has selected to redeem. For example, a user shopping at a grocery store goes to check out with 20 items. Of the 20 items, the user has merchant coupon offers for 5 of those items. The user presents the bar code display on the smart device, which is scanned by the checkout clerk. As a result, the discounted offer for those five products is automatically applied. This saves the user the necessity of scanning through all discount offers held in the memory of the user's smart device and having to individually scan each bar code. Alternatively, it is possible that the smart device could display in an accelerated manner all of the bar codes in memory, which allows the merchant's check out computer to apply only those codes for which a corresponding product was purchased.

A method and device for the offering and delivering electronic discount offers has been disclosed. In addition, a smart device for redeeming discount offers has been disclosed. This invention should not be construed as being limited by any specific example used herein, but is defined by the scope of the claims which follow.

I claim:

1. A method for the delivery of electronic discount offers comprising the steps of:
providing a first location accessible to merchants for the posting of discount offers;
providing a second location accessible to consumers for the selection of discount offers from among those offers posted by said merchants; and
transmitting said selected offers to a first device, said device being capable of receiving said messages and relaying said messages to a second device via a wireless communications link.

2. The method of claim 1 wherein said first and said second locations are one or more web sites accessible over a communications network.

3. The method of claim 2 wherein said communications network is the Internet

4. The method of claim 1 wherein said first device is selected from a group composed of a cellular telephone, a beeper, a personal data assistant, a handheld computer, a checkout register and a personal computer.

5. The method of claim 1 wherein said communications link is an RF link.

6. The method of claim 2 wherein said discount offers posted by said merchants are categorized into one or more categories.

7. The method of claim 6 wherein said categories are predefined.

8. The method of claim 6 wherein one of said merchants can bid against all other of said merchants for priority placement of said merchant's discount offer within one or more of said categories.

9. The method of claim 8 wherein said bid is a flat amount per category.

10. The method of claim 8 wherein said bid is an amount to be paid on a per-redemption basis.

11. The method of claim 2 further comprising the step of allowing said users to search for offers of interest based on various search criteria.

12. The method of claim 11 wherein said search criteria is selected from a group composed of product or service category, ZIP code, and said user's current location.

13. The method of claim 11 further comprising the step of providing, to each of said users, a private folder in which to store one or more of said selected offers.

14. The method of claim 13 further comprising the step of allowing said merchants to place offers directly into the private folders of said users.

15. The method of claim 14 wherein said offers placed into said private folders of said users are based on offers which have been previously redeemed by said user.

16. The method of claim 14 wherein said offers placed into said private folders of said users are based on offers which said user has moved into said private folder but has not yet redeemed.

17. The method of claim 13 wherein said offers in said private folder of a particular user are automatically transmitted to said first device associated with said user.

18. The method of claim 13 wherein said first device is web-enabled and wherein said user can access said web site using said first device.

19. The method of claim 18 wherein said first device is location aware and further comprising the step of searching for one or more of said offers based on said location.

20. The method of claim 18 wherein said second device is location-aware and further wherein said location information can be communicated to said first device via said communications link.

21. The method of claim 20 wherein said first device derives its location awareness from a built in GPS receiver.

22. The method of claim 21 wherein said second device derives its location awareness from a built in GPS receiver.

23. The method of claim 13 wherein offers are placed into said private folders of said users automatically base on past redemption behavior and predicted future redemption behavior.

24. A method for the delivery of electronic discount offers comprising the steps of:
providing a first location accessible to merchants for the posting of discount offers;
providing a second location accessible to consumers for the selection of discount offers from among those offers posted by said merchants; and
providing all or a subset of all offers posted by all merchants to a third party for transmission to via a wireless communications link to a device capable of displaying a scannable bar code.

25. The method of claim 24 wherein said third party is a merchant.

26. The method of claim 1 wherein a plurality of offers are transmitted as a single offer.
